(19) United States
(12) Patent Application Publication
(10) Pub. No.: US 2011/0054665 A1
(43) Pub. Date: Mar. 3, 2011

(54) MACHINE TOOL DEVICE HAVING A MONITORING UNIT

(76) Inventors: Jochen Wingbermuehle, Hemmingen (DE); Matthias Heiler, Zurich (CH)

(21) Appl. No.: 12/808,240

(22) PCT Filed: Oct. 30, 2008
(86) PCT No.: PCT/EP2008/064734

§ 371 Date: Nov. 18, 2010

(30) Foreign Application Priority Data
Dec. 21, 2007 (DE) 102007062951.8

(51) Int. Cl. G05B 19/406

(52) U.S. Cl. 700/174

(57) ABSTRACT

A machine tool device having a monitoring unit for monitoring at least one machine tool monitoring range, the monitoring unit having a control unit. The control unit is provided for carrying out a recording mode, before a workpiece machining operation, in which a feature parameter is recorded for a feature which is to be taken into account in the workpiece machining operation.

### FIELD OF THE INVENTION

The present invention is directed to a machine tool device.

### BACKGROUND INFORMATION

A circular table saw has previously been proposed which has a video camera for monitoring a hazard range.

### SUMMARY OF THE INVENTION

The exemplary embodiments and/or exemplary methods of the present invention is directed to a machine tool device having a monitoring unit for monitoring at least one machine tool monitoring range, the monitoring unit having a control unit.

It is proposed that the control unit is provided for carrying out a recording mode, before a workpiece machining operation, in which a feature parameter is recorded for a feature that is to be taken into account in the workpiece machining operation. By recording the feature parameter, a high level of flexibility in using the machine tool device may be easily achieved by the fact that the machine tool device may be adapted to various machining conditions. Carrying out the recording mode before the workpiece machining operation allows a particularly high level of safety to be achieved for the workpiece machining operation, it being advantageously possible with the aid of the feature parameter to quickly and reliably recognize a hazard situation for the workpiece machining operation. High efficiency in recognition may be achieved, and simple, cost-effective classification processes may be used. A feature parameter “for” a feature refers in particular to a parameter which is specifically selected to characterize the feature. A “recording” of a feature parameter refers in particular to an operation in which the feature parameter is obtained and is treated in such a way that it is available for a further operation, in particular a recognition operation, at least for the duration of the workpiece machining operation. The operation for obtaining the feature parameter may be a detection operation in which the feature parameter is detected, or may involve an ascertainment operation in which the feature parameter is ascertained based on other detected data. The machine tool device may have a detection unit and/or a computing unit. The detection unit may be used for detecting the feature parameter and/or for detecting data, and the computing unit may be used for ascertaining the feature parameter based on these data.

The machine tool device also may have a memory unit in which the feature parameter is stored, at least until the workpiece machining operation has ended. The control unit may have at least one computing unit, and one memory unit in which control instructions for carrying out the recording mode by the computing unit are stored. A “workpiece machining operation” refers in particular to an operation in which a workpiece is machined using a tool which is in a state that is driven by a drive unit. The recording mode is carried out “before” the workpiece machining operation, in particular by carrying out the recording mode before the drive unit is started. During the workpiece machining operation a feature is “taken into account” in particular by using the appropriate feature parameter in a monitoring operation of the monitoring unit. The term “provided” is understood in particular to mean “designed,” “equipped,” and/or “programmed.”

In one embodiment of the present invention, the monitoring unit has an imaging unit which is operatively linked to the control unit for carrying out the recording mode. High information density may be achieved by imaging when the recording mode is carried out. In recording mode, the feature parameter may be obtained by evaluating image data detected by the imaging unit. For this purpose, the monitoring unit may have an evaluation unit, having an image processing program in particular, which is provided for evaluating image data for obtaining the feature parameter. The imaging unit is provided in particular for detecting images in the visible range. Alternatively or additionally, the imaging unit may be provided for detection in an invisible range.

It is further proposed that the feature relates to an environmental condition which is external to a workpiece. Safety of use may thus be further increased. An “environmental condition which is external to a workpiece” refers in particular to a condition which, in contrast to an intrinsic characteristic of a workpiece, concerns the surroundings or the environment of a workpiece to be machined, in particular prior to workpiece machining. A feature parameter for a feature relating to such an environmental condition may be recorded independently of or in addition to recording a feature parameter which characterizes an intrinsic characteristic of a workpiece, such as a material feature, for example.

The recording mode is used in particular to record a user feature parameter for a user feature relating to a machine tool user. When the workpiece machining operation is carried out it is thus possible to achieve particularly quick and reliable recognition of a hazard situation which in particular represents a potential risk of injury to the user. In this recording mode the user may in particular be prompted to place a body part in the detection range of a detection unit.

The recording mode is advantageously used to record a workpiece feature parameter for a workpiece feature relating to a workpiece to be machined, thus allowing the monitoring unit to be advantageously adapted to a workpiece to be machined. In this recording mode the user may be prompted to place the workpiece to be machined or a material sample of the same material in the detection range of a detection unit.

It is further proposed that the monitoring unit has a computing unit which is provided for ascertaining at least one distinguishing parameter for a feature which distinguishes between the user feature and a workpiece feature relating to a workpiece to be machined. A differentiation between a user feature and a workpiece feature may thus be quantitatively characterized in a particularly advantageous manner by use of a variable.

In this regard, a high level of user convenience may be achieved by the fact that the machine tool device has a warning unit which is provided for emitting a warning signal as a function of the distinguishing parameter. In particular, the user may thus be informed of potentially inadequate protection during the workpiece machining operation.

The machine tool monitoring device advantageously has a recognition unit which is provided for recognizing the presence of a user body part in the machine tool monitoring range during the workpiece machining operation, at least with the aid of the user feature parameter. Simple discriminant rules which are to be evaluated with little computational complexity may thus be used.

In another embodiment of the present invention it is proposed that the machine tool device has a memory unit, the memory unit being provided to store values of at least one feature parameter in at least one operating mode, the values in each case being associated with various environmental conditions. Operator convenience may thus be further increased. The values in particular correspond to values of at least one feature parameter, these values in each case being associated with different users. Alternatively, the values correspond to values of at least one feature parameter, these values in each case being associated with different lighting conditions. User and/or lighting condition profiles may thus be advantageously provided.

It is further proposed that the feature is a feature from the group composed of color, contour, and texture, thus allowing a high level of recognition to be achieved.

Moreover, the exemplary embodiments and/or exemplary methods of the present invention is directed to a method which includes a machine tool, in which a machine tool monitoring range is monitored with the aid of a monitoring unit.

It is proposed that a user feature recording mode is carried out in which a body part of a machine tool user situated in the machine tool monitoring range is detected, and based on the detection operation at least one user feature is recorded for a user feature relating to the machine tool user, and a workpiece is subsequently machined using the machine tool, taking the user feature into account. It is thus possible to recognize a hazard situation in a particularly quick and reliable manner when the workpiece machining operation is carried out.

It is further proposed that before machining the workpiece, a workpiece feature recording mode is carried out in which a workpiece material situated in the machine tool monitoring range is detected, and based on the detection operation at least one workpiece feature parameter is recorded for a workpiece feature relating to the workpiece. In this regard it is proposed that before machining the workpiece, at least one distinguishing parameter for a feature which distinguishes between the user feature and the workpiece material is evaluated. A differentiation between a user feature and a workpiece feature may thus be quantitatively characterized in a particularly advantageous manner by use of a variable.

It is further proposed that the user feature recording mode and the workpiece feature recording mode are carried out successively or simultaneously. A particularly high level of differentiation may thus be achieved by the fact that a feature parameter for a user feature and a feature parameter for a workpiece feature may be recorded under essentially constant lighting conditions.

Further advantages result from the following description of the drawing. The drawing illustrates exemplary embodiments of the present invention. The drawing, description, and claims contain numerous features in combination. One skilled in the art will advantageously also consider the features individually and combine them to form further practical combinations.

### BRIEF DESCRIPTION OF THE DRAWINGS

FIG. 1 shows a circular table saw having a monitoring unit.

FIG. 2 shows an internal circuit having the monitoring unit which includes a video camera, an evaluation unit for ascertaining feature parameters, and a control unit.

FIG. 3 shows a memory unit of the evaluation unit in which feature parameters are stored.

FIG. 4 shows the circular table saw during the detection of a hand and the ascertainment of a user feature parameter.

FIG. 5 shows the circular table saw during the detection of a material sample and the ascertainment of a workpiece feature parameter.

FIG. 6 shows the circular table saw during simultaneous detection of a hand and a material sample.

### DETAILED DESCRIPTION

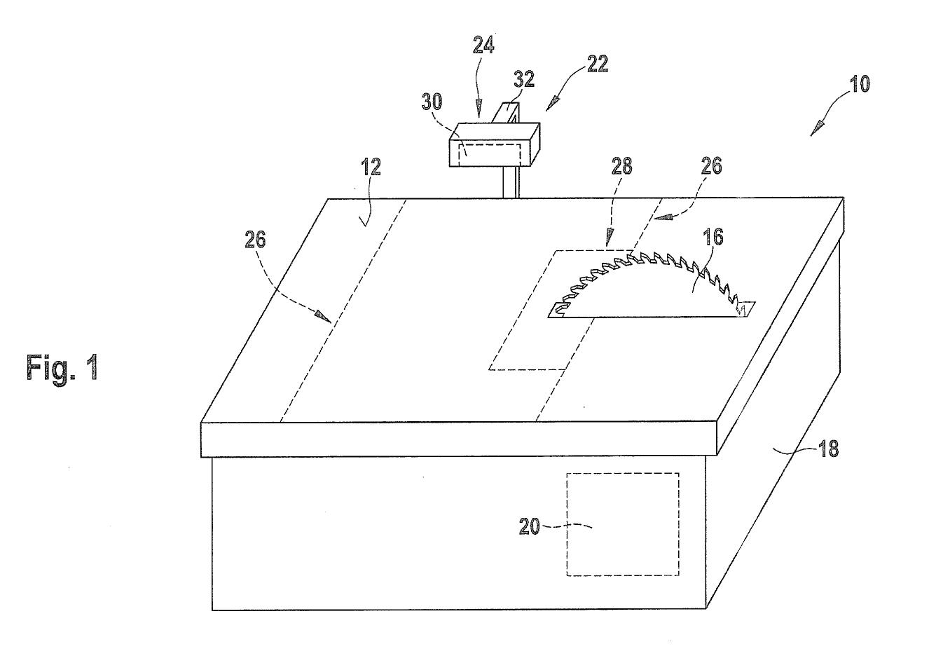

FIG. 1 shows a machine tool 10 designed as a circular table saw, in a perspective view. The machine tool has a work surface 12 which is designed as a workpiece support surface for laying a workpiece to be machined, and which is horizontally oriented in a base mounting position of machine tool 10. A tool 16 designed as a circular saw blade projects from work surface 12. In a workpiece machining operation, tool 16 is set in rotation by a drive unit 20 which is located in a drive housing 18 situated beneath work surface 12 and which is designed as an electric motor.

Machine tool 10 includes a machine tool device 22 having a monitoring unit 24. This monitoring unit 24 is provided for monitoring a machine tool monitoring range 26. The boundary of machine tool monitoring range 26 on work surface 12 is schematically illustrated by dashed lines in FIG. 1. Machine tool monitoring range 26 contains a partial range of work surface 12, and also extends vertically upward starting from work surface 12. Machine tool monitoring range 26 has a partial range situated in the range of tool 16. This partial range, referred to as hazard range 28, is in the immediate proximity of tool 16. In particular, hazard range 28 directly adjoins tool 16. This hazard range 28 represents a range in which intrusion of a body part of an operator of machine tool 10 is to be avoided. Monitoring unit 24 has a detection unit 30, designed as an imaging unit, which is used to detect machine tool monitoring range 26. For this purpose, detection unit 30 has a field of vision corresponding to machine tool monitoring range 26 to be monitored. In the exemplary embodiment shown, detection unit 30 is situated in a position over work surface 12. Machine tool device 22 has a retaining device 32 which is provided for holding detection unit 30 in this position. Additional configurations of detection unit 30 relative to work surface 12 are possible which are meaningful to one skilled in the art.

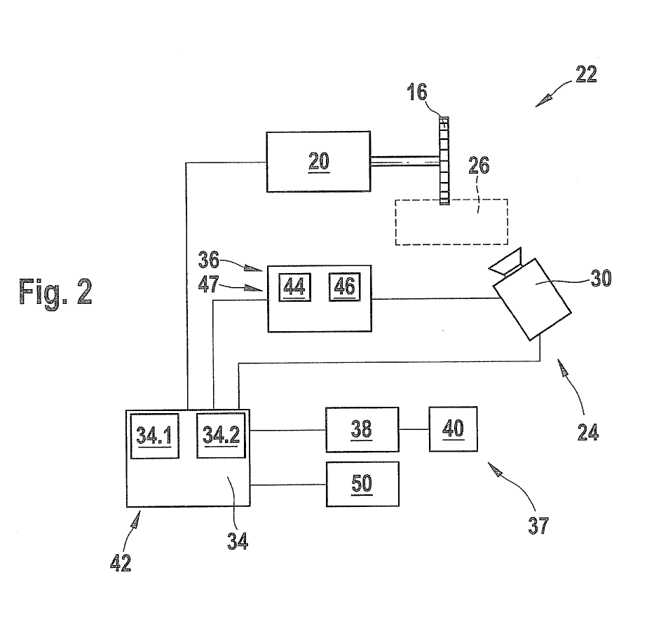

FIG. 2 schematically illustrates an internal circuit of machine tool 10. Machine tool device 22 has a control unit 34 which is provided for carrying out operating modes of machine tool 10. Control unit 34 is a component of monitoring unit 24, and is operatively linked to detection unit 30. The control unit has a computing unit 34.1 designed as a processor, and a memory unit 34.2. In particular, programs are stored in memory unit 34.2 which are used by computing unit 34.1 for carrying out operating modes. Control unit 34 is operatively linked to drive unit 20, and is able to transmit control signals to drive unit 20 for controlling and/or regulating a drive of tool 16. In addition to detection unit 30 described above, monitoring unit 24 has an evaluation unit 36 which is operatively linked to detection unit 30 and to control unit 34, and whose function is described in greater detail below. Evaluation unit 36 and control unit 34 together may have at least a partially one-piece design.

Machine tool device 22 also has a safety device 37 which is used to carry out safety measures for an operation of machine tool 10. For this purpose, safety device 37 has an actuator unit 38 which is designed to carry out safety measures which relate to tool 16. According to these safety measures, this tool must be, for example, stopped or moved to a range that is inaccessible to the operator when there is risk of injury to the operator. Actuator unit 38 is used to trigger a securing means 40 operatively linked thereto. In a first alternative, securing means 40 is designed to stop a motion of tool 16 when triggered by actuator unit 38. Securing means 40 is designed as clamping means or braking means, for example. In another variant, securing means 40 is designed to lower tool 16 into a range of drive housing 18 beneath work surface 12, which is inaccessible to the user, when triggered by actuator unit 38. In another embodiment, securing means 40 may be designed as covering means for covering tool 16. Securing means 40 is triggered by actuator unit 38 when the actuator unit receives an actuating signal of control unit 34. Control unit 34 outputs this actuating signal to actuator unit 38 as a function of a signal of evaluation unit 36. As an alternative or in addition to actuator unit 38, an actuator unit 42 of machine tool device 22 is provided which corresponds to control unit 34. Actuator unit 42, designed as control unit 34, transmits a control signal to drive unit 20 as a function of a signal of evaluation unit 36, thus stopping the drive of tool 16. Thus, a safety measure is carried out by actuator unit 38 and/or 42 as a function of a signal of evaluation unit 36 which triggers activation of actuator unit 38 or 42 by control unit 34. The signal of evaluation unit 36 is transmitted to control unit 34 when a hazard situation is recognized for a drive of tool 16 with the aid of an evaluation operation based on data, in particular image data, detected by detection unit 30. This recognition process is described in greater detail below.

According to the exemplary embodiments and/or exemplary methods of the present invention, control unit 34 is provided for carrying out a recording mode before a workpiece machining operation is begun. In this recording mode, feature parameters are recorded which characterize a machining condition which is present prior to the workpiece machining operation. These feature parameters characterize in particular features which are taken into account in a workpiece machining operation following the recording mode.

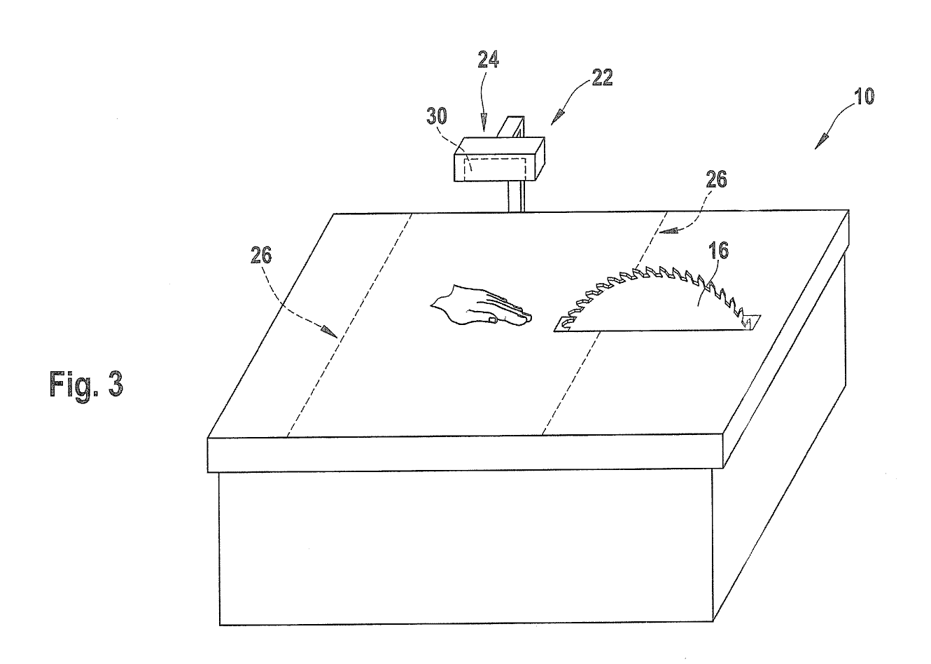

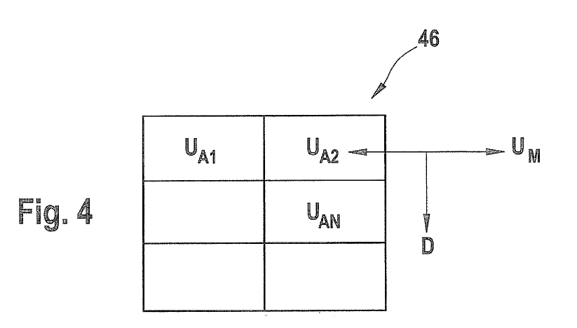

In a first recording mode a recorded feature parameter characterizes a user feature relating to a user of machine tool 10. This feature parameter is referred to as user feature parameter U_{A}. Carrying out the first recording mode is explained with reference to FIG. 3. Prior to a workpiece machining operation, the user of machine tool 10 places a hand in machine tool monitoring range 26, i.e., in the field of vision of detection unit 30, which is designed as a video camera which is provided for detecting images in the visible range. A design of detection unit 30 for detection in an invisible range, for example in an infrared range, is also possible. Detection unit 30 detects image data after the hand is placed on work surface 12 in machine tool monitoring range 26. This detection operation is controlled by control unit 34, which is operatively linked to detection unit 30 for carrying out the recording mode. The image data are then evaluated in evaluation unit 36. Evaluation unit 36 has a computing unit 44 for this purpose. Computing unit 44 may have a microprocessor or may be designed as a microprocessor. The computing unit evaluates image data of detection unit 30 with the aid of a program, in particular an image processing program, stored in a memory unit 46 of evaluation unit 36. On the basis of the image data, computing unit 44 ascertains at least the, or multiple, user feature parameter(s) U_{A} which characterize(s) a texture feature, a color feature, and/or a contour feature of the detected hand. Wearing of a protective material, in particular a glove, by the user may be taken into account in the ascertainment of user feature parameters U_{A}. These user feature parameters U_{A} are then stored in memory unit 46 of evaluation unit 36, as shown in FIG. 4, which schematically illustrates memory unit 46.

It is assumed that the user begins a workpiece machining operation. The workpiece machining operation is considered to have begun when a drive of tool 16 is started by control unit 34. The features which are characterized by user feature parameters U_{A} are taken into account when the workpiece machining operation is carried out, and are included in a monitoring operation of monitoring unit 24. During machining, the user pushes a workpiece placed on work surface 12 toward rotating tool 16. Detection unit 30 continuously records image data. These image data are continuously evaluated for recognition of the presence of the user's hand. Evaluation unit 36 is used as recognition unit 47, which is provided for recognizing the presence of a body part of a user of machine tool 10 in machine tool monitoring range 26, based on a user feature parameter U_{A}. For this purpose, evaluation results ascertained based on the image data are compared to user feature parameters U_{A} stored in memory unit 46. If the hand passes into machine tool monitoring range 26 detected by detection unit 30, computing unit 44 ascertains a parameter which at least substantially corresponds to a user feature parameter U_{A}, the presence of the hand in machine tool monitoring range 26 being recognized by evaluation unit 36. The motion of the hand in machine tool monitoring range 26 is then followed by the occurrence of a hazard situation, such as in particular the intrusion of the hand into hazard range 28, or the recognition of a slipping motion in a recognition operation (not described in greater detail) of evaluation unit 36. If such a hazard situation arises, evaluation unit 36 transmits a signal to control unit 34, which activates actuator unit 38 and/or 42 as described above.

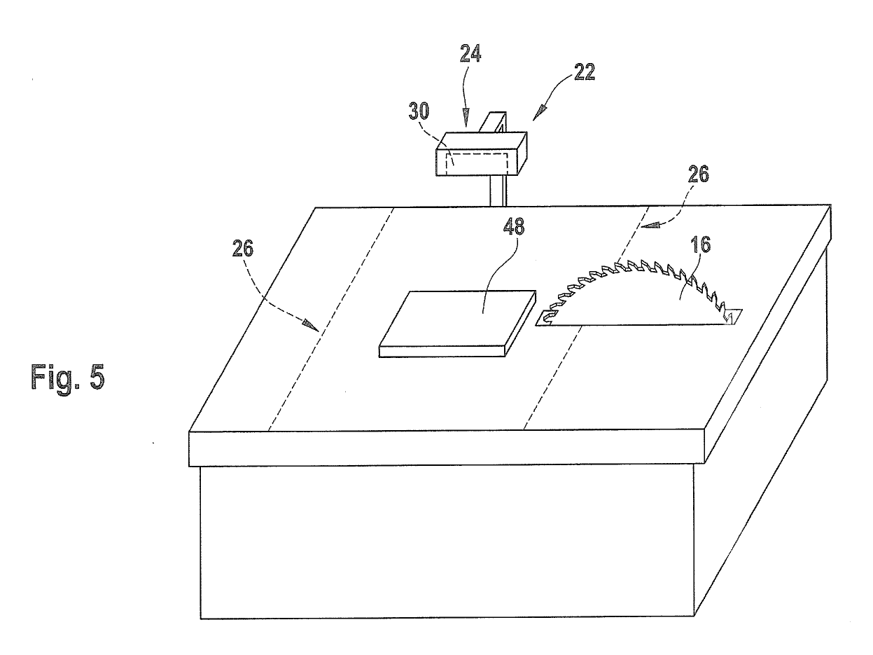

Control unit 34 is also provided for carrying out a further recording mode in which a feature parameter is recorded which characterizes a workpiece feature relating to a workpiece to be machined. This feature parameter is referred to as workpiece feature parameter U_{M}. In this recording mode the user is prompted to place a workpiece to be machined, or a material sample having the same material properties as the workpiece, in machine tool monitoring range 26. This is illustrated in FIG. 5, in which a material sample 48 is situated in the field of vision of detection unit 30. Detection unit 30 detects image data, which are then evaluated by computing unit 44 of evaluation unit 36. The image data may be examined for at least one feature which corresponds to a feature that is examined in the evaluation of image data of a body part of the user, as described above. This feature in particular is a feature from the group composed of color, contour, and texture. In the evaluation, workpiece feature parameters U_{M} relating to a workpiece to be machined are evaluated. If user feature parameters U_{A} are already present, feature parameters U_{M} and U_{A} are compared to one another.

This is schematically illustrated in FIG. 4. If these user feature parameters are not present, the user is prompted to place a hand in machine tool monitoring range 26. The evaluation process described above is then carried out. Computing unit 44 then ascertains at least one distinguishing parameter D which thus characterizes at least one feature which distinguishes between a user feature and a workpiece feature. If at least one distinguishing parameter D corresponds to a distinguishing feature via which an adequate differentiation may be made between a user feature and a workpiece feature, a workpiece machining operation may be begun by the user. This condition corresponds to a quantitative condition for distinguishing parameter D: an “adequate” differentiation corresponds to a quantitative condition, for example a minimum value which is intended to satisfy distinguishing parameter D. If computing unit 44 is unable to ascertain a distinguishing parameter D via which an adequate differentiation may be made, i.e., which satisfies a corresponding quantitative condition, evaluation unit 36 transmits a signal to control unit 34, which transmits a control signal to a warning unit 50, which generates a warning signal for acoustically and/or optically warning the user. This warning is thus made as a function of distinguishing parameter D. The user is thus informed that no significant differentiation could be made between features of material sample 48 and features of the hand.

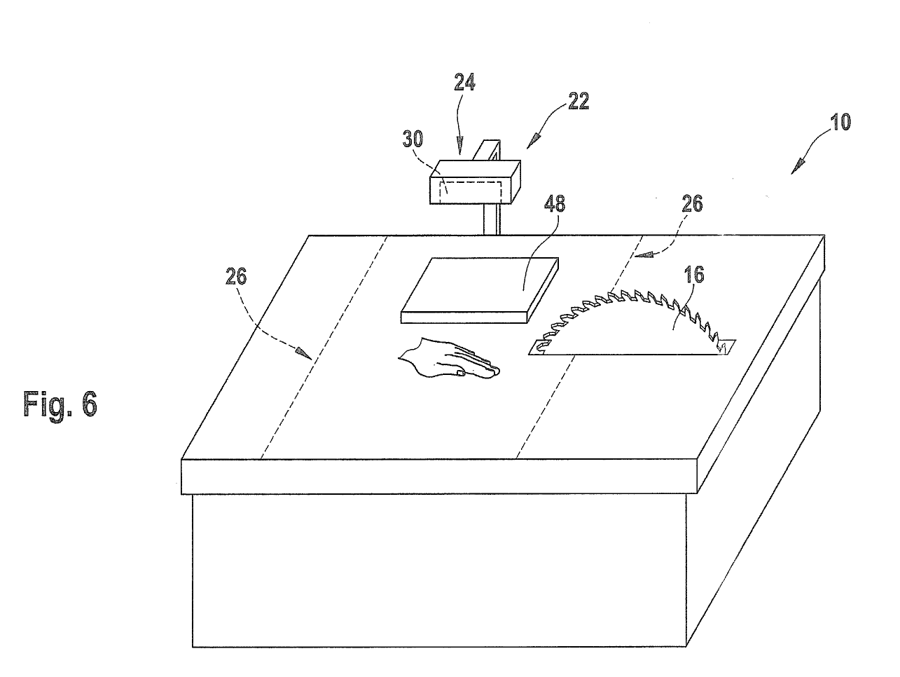

If in the second recording mode the ascertainment of distinguishing criteria has failed, or there is doubt concerning the distinguishability of the hand and the workpiece, a further recording mode may be carried out by control unit 34. The user is prompted to place a hand and material sample 48 in machine tool monitoring range 26. This is illustrated in FIG. 6. Alternatively, the user may place the workpiece to be machined on work surface 12, and place his hand on the workpiece. Computing unit 44 then ascertains feature parameters U_{A} and U_{M} as described above. A more precise differentiation may be made when the hand and material sample 48 are simultaneously present in the field of vision of detection unit 30, due to the fact that the hand and material sample 48 are detected under identical lighting conditions. The recording mode is terminated when computing unit 44 ascertains a distinguishing parameter D via which an adequate differentiation may be made. In another possible embodiment, a recording mode for recording a user feature parameter U_{A} and a recording mode for recording a workpiece feature parameter U_{M} may follow one another in direct succession. The user is prompted to successively place a hand and material sample 48, or in the reverse sequence, in the field of vision of detection unit 30. The operations for obtaining feature parameters U_{A} and U_{M} may likewise be carried out under identical lighting conditions.

In the recording modes described above, the hand or material sample 48 may be placed in a partial range of machine tool monitoring range 26 which is provided specifically for recording the object to be examined. This partial range may be marked, for example with the aid of a marking unit. The hand and/or material sample 48 may thus be successively detected under identical lighting conditions.

The recording modes described above may optionally be repeated by the user. This is appropriate in particular when an environmental condition such as a lighting condition, for example, has changed. When a recording mode is repeated, ascertained feature parameters U_{A} and/or U_{M} may replace the previous feature parameters. In one embodiment variant it is possible to maintain feature parameters U_{A} and/or U_{M} which are already present, the newly ascertained feature parameters also being stored in memory unit 46. Multiple lighting profiles may thus be obtained which in each case characterize a typical lighting configuration and which may be retrieved by the user. The recording modes may also be carried out again when another type of workpiece is machined, or when machine tool 10 is used by another user. Newly ascertained feature parameters U_{M} or U_{A} may replace the existing feature parameters, or workpiece profiles and/or user profiles may be generated which may be retrieved by the user when a typical application situation is present.

Machine tool device 22 is also suited for other types of machine tools, for example compound miter saws, miter saws, band saws, etc.

1-12. (canceled)

13. A machine tool device, comprising:
a monitoring unit for monitoring at least one machine tool monitoring range, the monitoring unit including:
a control unit for carrying out a recording mode, before a workpiece machining operation, in which a feature parameter is recorded for a feature which is to be taken into account in the workpiece machining operation.

14. The machine tool device of claim 13, wherein the monitoring unit includes an imaging unit for carrying out the recording mode, and which is operatively linked to the control unit.

15. The machine tool device of claim 13, wherein the recording mode is used to record a user feature parameter for a user feature relating to a machine tool user.

16. The machine tool device of claim 15, wherein the recording mode is used to record a workpiece feature parameter for a workpiece feature relating to a workpiece to be machined.

17. The machine tool device of claim 15, wherein the monitoring unit includes a computing unit, which is provided for ascertaining at least one distinguishing parameter for a feature which distinguishes between the user feature and a workpiece feature relating to a workpiece to be machined.

18. The machine tool device of claim 17, further comprising:
a warning unit for emitting a warning signal as a function of the distinguishing parameter.

19. The machine tool device of claim 15, further comprising:
a recognition unit for recognizing the presence of a user body part in the machine tool monitoring range during the workpiece machining operation, at least with the aid of the user feature parameter.

20. The machine tool device of claim 13, wherein the feature is a at least one of a color, a contour, and a texture.

21. A machine tool, comprising:
a machine tool device, including:
a monitoring unit for monitoring at least one machine tool monitoring range, the monitoring unit including:
a control unit for carrying out a recording mode, before a workpiece machining operation, in which a feature parameter is recorded for a feature which is to be taken into account in the workpiece machining operation.

22. A method for using a machine tool, the method comprising:
monitoring a machine tool monitoring range the aid of a monitoring unit, wherein a user feature recording mode is carried out in which a body part of a machine tool user situated in the machine tool monitoring range is detected;
recording, based on the detection operation, at least one user feature parameter for a user feature relating to the machine tool user; and
subsequently machining a workpiece using the machine tool and taking the user feature into account;
wherein the machine tool includes:
a machine tool device, including:
the monitoring unit for monitoring at least one machine tool monitoring range, the monitoring unit including:
a control unit for carrying out a recording mode, before a workpiece machining operation, in which a feature parameter is recorded for a feature which is to be taken into account in the workpiece machining operation.

23. The method of claim 22, wherein before machining the workpiece, a workpiece feature recording mode is carried out in which a workpiece material situated in the machine tool monitoring range is detected, and based on the detection operation at least one workpiece feature parameter is recorded for a workpiece feature relating to the workpiece.

24. The method of claim 23, wherein before machining the workpiece, at least one distinguishing parameter for a feature which distinguishes between the user feature and the workpiece material is evaluated.
